(19) United States
(12) Patent Application Publication
(10) Pub. No.: US 2005/0038593 A1
(43) Pub. Date: Feb. 17, 2005

(54) Method for controlling the position of a camshaft actuator

(76) Inventors: Werner Mezger, Eberstadt (DE); Torsten Baumann, Eppingen-Adelshofen (DE)

Correspondence Address: Walter Ottesen;Patent Attorney, P.O. Box 4026, Gaithersburg, MD, 20885-4026, US

(21) Appl. No.: 10/669,808

(22) Filed: Sep. 25, 2003

(30) Foreign Application Priority Data
Sep. 25, 2002 (DE) 102 44 541.9

(51) Int. Cl. F01L 1/34; G05D 1/00; G06F 7/00; B60T 7/12; G06F 17/00

(52) U.S. Cl. 701/103; 123/90.15

(57) ABSTRACT

A precontrol is carried out for the control of the position of the camshaft via a camshaft actuator especially in internal combustion engines and preferably in such engines of motor vehicles. For this purpose, a control for the position of a camshaft is carried out by a camshaft actuator with reference to a reference position in dependence upon the actual position of the camshaft and in dependence upon a determined desired position for the camshaft. An actuating signal for driving the actuator for the camshaft is determined from the desired position and the actual position of the camshaft actuator. In the determination of the actuating signal, a precontrol component is considered which is determined based on state quantities characterizing the operation of the camshaft actuator.

### BACKGROUND OF THE INVENTION

It is known to adjust camshafts relative to a reference position in internal combustion engines and especially in internal combustion engines of motor vehicles. For this purpose, a camshaft actuator is actuated which shifts the rotational position of the camshaft relative to a reference position.

To control the position of the camshaft actuator, the desired position for the camshaft actuator is determined in a control apparatus from measured quantities supplied to the control apparatus. A control signal is derived from the actual value of the position of the camshaft actuator and the determined desired position.

With this procedure, a control of the position of a camshaft actuator takes place relative to a reference position. The control speed and the control quality of such a control are dependent upon the behavior of the camshaft actuator. For this purpose, the camshaft actuator has a driveable switch member which is assigned thereto and which influences the operating state of the camshaft actuator. Camshaft actuators are often hydraulically-operated actuators. The actual actuator of the camshaft actuator is a hydraulic work cylinder which is pressure charged with a hydraulic liquid. As a rule, an electromagnetically-actuated valve is assigned to the camshaft actuator as a switching member for controlling the inflow and outflow of the hydraulic liquid in the at least one work chamber of the camshaft actuator. Hydraulic work cylinder (actuator) and the switch member, which actuates the same, are often together referred to as a camshaft actuator. The term “camshaft actuator” is sometimes also used to characterize the actual work cylinder.

### SUMMARY OF THE INVENTION

It is an object of the invention to improve the quality of the control of a camshaft actuator.

The method of the invention is for controlling the position of a camshaft actuator. The method includes the steps of: controlling the position of a camshaft with respect to a reference position utilizing the camshaft actuator in dependence upon an actual position of the camshaft and in dependence upon a determined desired position of the camshaft; determining a precontrol component based on state quantities characterizing the operation of the camshaft actuator; and, determining an actuating signal for driving the camshaft actuator from the desired position and an actual position of the camshaft while considering the precontrol component.

According to the invention, a precontrol is carried out for the control of the position of the camshaft via the camshaft actuator especially in internal combustion engines and preferably in such engines for motor vehicles. For this purpose, a control for the position of a camshaft with respect to a reference position is carried out via a camshaft actuator in dependence upon the actual position of the camshaft and in dependence upon a determined desired position for the camshaft. An actuating signal for driving the actuator for the camshaft is determined from the desired position and actual position of the camshaft actuator. In the determination of the actuating signal, a precontrol component is considered in accordance with the invention and this precontrol component is determined based on state quantities characterizing the operation of the camshaft actuator. In this way, the behavior of the camshaft actuator is considered in the generation of the actuating signal driving the camshaft actuator. The essential behavior of the camshaft actuator is characterized by the actuating speed of the actuator in the travel direction which is to be generated based on the control deviation. The travel speed in the two possible travel directions (toward the reference position or away from the reference position) is not only different from camshaft actuator to camshaft actuator but is a quantity changing in dependence upon operating state based on the operating conditions of a camshaft actuator. For this reason, an improvement of the control quality and a reduction of the actuating duration, which is required for adjusting the desired position, can be achieved in a simple and cost effective manner via the consideration according to the invention of a corresponding precontrol component.

According to an embodiment of the invention, the precontrol component is determined based on state quantities which represent the state of the hydraulic liquid causing the actuating movement of the camshaft actuator. Here, at least one of the quantities of pressure and temperature of the hydraulic liquid is preferably used as state quantities. The consideration of state quantities, which relate to the hydraulic liquid, has a special advantage. The state of the hydraulic liquid first defines the inherent characteristic of this liquid. This characteristic of the hydraulic liquid, which functions as a work medium in the actuator, has a direct influence on the behavior of the actuator per se. Furthermore, the hydraulic oil and its physical state also influences the behavior of the switch member (actuator) which controls the inflow of the hydraulic oil into the work chamber of the work cylinder of the camshaft actuator. Here, especially the pressure and the temperature of the hydraulic liquid are decisive because these two quantities influence, on the one hand, the viscosity of the hydraulic liquid and, on the other hand, influence the switching speed of the actuator valve. The switching speed is, on the one hand, directly dependent upon the viscosity of the hydraulic liquid and, on the other hand, the temperature of the hydraulic liquid determines also the operating temperature of the switch means of the actuator valve, for example, of an electromagnet and therefore has also an influence on its response performance. According to an embodiment of the invention, the hydraulic oil can be the engine oil circulating in the engine. For the purposes of the camshaft control, the engine oil can be branched off at the pumped end of the engine oil circulation which is pressure-charged by the engine oil pump.

The tendency is that the viscosity becomes less with increasing temperature of the hydraulic liquid and therefore the valve-opening times decrease which are required for generating an actuating path of the camshaft actuator. Likewise, the valve-opening times, which are required for the generation of an actuating path of the camshaft actuator, increase with increasing pressure of the hydraulic liquid. The determination of the precontrol component from the state quantity “oil temperature” and/or “oil pressure” takes place either from corresponding characteristic lines or even from a modeling of the characteristic of the actuator and of the switch member actuating the actuator. The determination of the precontrol component must always be adapted to the conditions which are present in the particular internal combustion engine. These conditions are, for example, the arrangement and dimensioning of work cylinder and hydraulic lines and characteristics of the switch member.

According to an advantageous embodiment of the invention, the determination of the precontrol component takes place while utilizing the state quantity “on-board voltage”. The on-board voltage is a state quantity which is decisive for the behavior of an electromagnetic switch member. The higher the on-board voltage, the lower is the flight time of the armature, which is charged by the electromagnet, between its two end positions. For this reason, the switch time of the valve is less during which a part of the maximum valve throughflow takes place. With increasing on-board voltage, the required duration of current flow of the valve for achieving a defined actuating movement becomes less.

Advantageous embodiments of the invention provide that at least a portion of the state quantities is detected via sensors. A portion of the state quantities can anyway be present as measured quantities and therefore need only be transmitted to the control apparatus in which the precontrol is determined. On the other hand, it is also possible to directly supply signals to this control apparatus from corresponding sensors and/or evaluation units assigned thereto. According to another embodiment, at least a portion of the state quantities is derived from other quantities measured especially by means of sensors. The determination of the state quantities is preferably made with models or from corresponding characteristic lines. The model-supported determination is a possibility to consider state quantities which are not measured directly but can be derived from quantities, which are anyway measured, via model-supported determination. Additional sensors, which are required only for the execution of the precontrol, are avoided, so that for the precontrol only slight additional cost and no increased complexity of components arise. The precontrol can be undertaken especially in the control apparatus which undertakes the control of the camshaft actuator. In this case, the method is stored as an executable computer program in a memory component and is carried out on a computer of the control apparatus such as a microchip.

For example, when engine oil is branched off at the pump output end of the engine oil pump as hydraulic fluid, the pressure can be derived from the engine rpm because the engine oil pump is driven directly by the control chain or the control belt which is connected to the crankshaft. Seen qualitatively, an excessively high prepressure results at the input of the switch member of the camshaft actuator at low engine rpm and low oil temperature because of the low viscosity of the engine oil. At low engine rpm and high oil temperature, the prepressure at the input of the switch member of the camshaft actuator is less than the actually wanted value because of the leakages in the engine oil circulation which occur at low viscosity. Correspondingly, the modeling of the oil pressure from the engine rpm must include a corresponding temperature-dependent component. The model and the corresponding adaptation of the precontrol to the oil pressure, which is present relative to the desired pressure, can be also determined empirically as may be required.

The oil temperature can also be derived with a model from the operation of the internal combustion engine or from the cooling water temperature. If characteristic lines are used, the modeling can be adapted subliminally via a corresponding adaptation of the course of the characteristic line to the measured quantities used indirectly for state quantities.

According to another feature of the method, as precontrol component, a signal is determined by which the actuating signal is changed especially via additive or multiplicative logic operation. This procedure makes possible a simple, quasi-modular connection of the precontrol to the control of the position of the camshaft actuator. The control takes place in a specific suitable manner known per se. The actuating signal, which is generated by the control, is not directly transmitted to the camshaft actuator or its switch member. Rather, this signal is first logically coupled to the precontrol component.

According to another embodiment of the invention, the actuating signal is a clock signal which causes current to be supplied to the electromagnet. The pressure of the hydraulic liquid present in a work chamber of the actuator is dependent upon the opening duration of the clock controlled switch member “electromagnetic valve” and the pulse-duty factor of the clock signal. The pressure downstream is that of a switch member wherein the work chamber is filling with hydraulic liquid and is under a prepressure and the pressure upstream is that of a switch member wherein the work chamber is venting hydraulic liquid. The pulse-duty factor is adapted in correspondence to the precontrol component, that is, it is increased or decreased. The clock signal is, as a rule, the signal driving a power amplifier which supplies current to the electromagnet in dependence upon the clock signal.

### BRIEF DESCRIPTION OF THE DRAWINGS

The invention will now be described with reference to the drawings wherein:

FIG. 1 is a schematic block circuit diagram of a precontrol according to the invention; and,

FIG. 2 is a plot of the adjusting speed of the camshaft actuator which results from the pulse-duty factor of the drive.

### DESCRIPTION OF THE PREFERRED EMBODIMENTS OF THE INVENTION

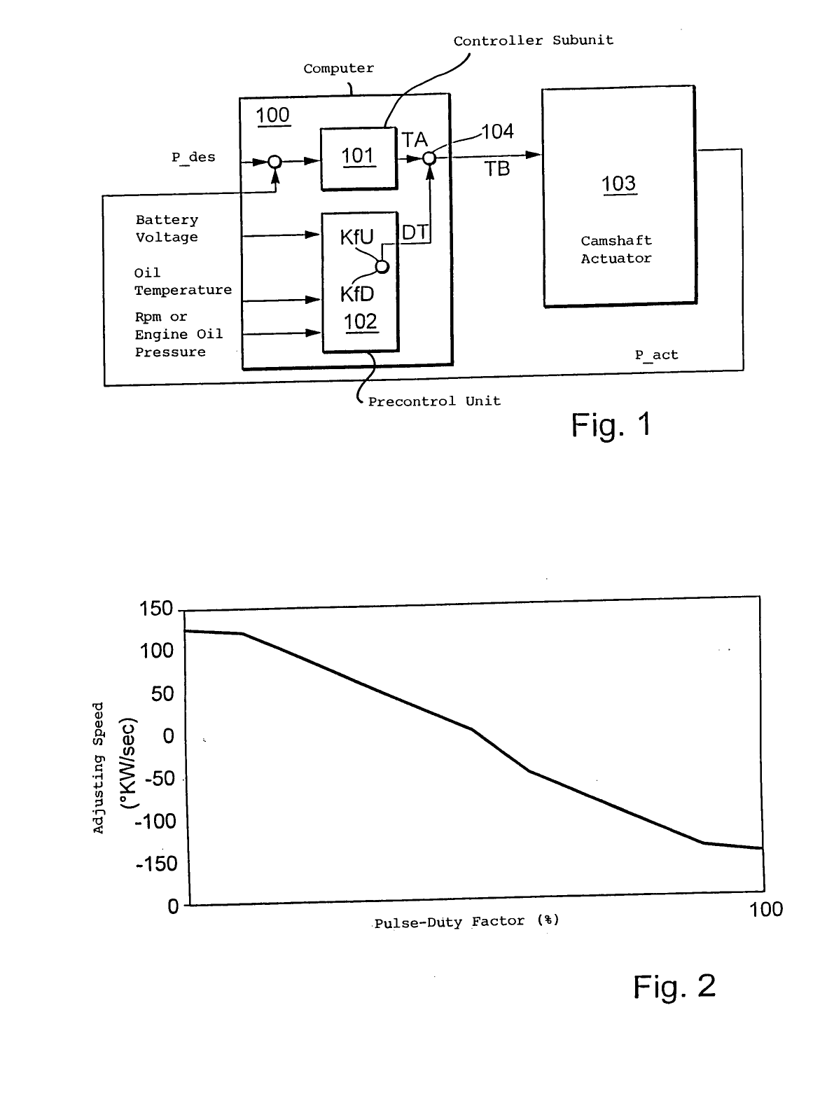

FIG. 1 shows a block circuit diagram of the method according to the invention. Here, the control for the precontrol takes place in computer 100. A determined desired value P_des as well as the actual value P_act for the position of the camshaft actuator are supplied to the computer 100. Furthermore, other signals are supplied which represent the on-board voltage U_on-board, the temperature T_oil of the engine oil and the engine rpm (n).

In the controller subunit 101 of the computer 100, the control deviation is determined from the desired position P_des and the actual position P_act and an actuating signal, which results therefrom, is determined. The actuating signal is the clock signal TA for the clocked drive of the power amplifier, which supplies current to the electromagnet for switching the same. The clock signal is, for example, a rectangular waveform whose signal level is set to the logic value “1” for a changeable component (pulse-duty factor) of a sequentially repeating period. The logical value “1” corresponds to supplying current to the electromagnet and an opening or closing of a switch valve assigned to the work cylinder of the camshaft actuator. In the remaining time span of the period, the clock signal has a logical value “0” so that the electromagnetic is not actuated during this time and, accordingly, the valve, which is actuated by the electromagnet, is in the other switch position.

Without undertaking a precontrol, the clock signal TA would be supplied to the end amplifier and the electromagnet would be supplied with current corresponding to this signal.

A precontrol component DT is determined in the precontrol unit 102 based on the additionally supplied signals U_on-board, T_oil and (n). For this purpose, a value for the oil pressure is determined from the engine oil temperature T_oil and the engine rpm, for example, based on a suitable model. A corresponding corrective factor KfD is then derived from this value for the oil pressure and this corrective factor undertakes the adaptation of the behavior of the actuator to the behavior of an actuator working at the rated oil pressure. The determination of the corrective factor KfD can take place via an empirically determined characteristic line or a computer modeling. At the same time, the adaptation to the behavior of the switch member takes place relative to the fluctuations of the on-board voltage U_on-board. For example, a linear adaptation takes place via a corrective factor KfU according to the equation KfU=U_on-board/U_rated, wherein U_rated is the rated voltage of the on-board electrical system (for example, 13.5 volts). The two corrective factors KfU and KfD are multiplied by each other and one obtains the precontrol component DT in accordance with the equation DT=KfU*KfD. The precontrol component DT is supplied to the logic decision element 104. In the logic decision element 104, the pulse-duty factor of the clock signal TA is changed in correspondence to the value of the precontrol component DT. This results in the actuating signal TB which considers the precontrol. With this actuating signal TB, the switch member of the camshaft actuator is driven.

The diagram of FIG. 2 shows the actuating speed of a camshaft actuator which results from the pulse-duty factor of the clock signal which is used as the actuating signal. For a pulse-duty factor of 50%, the camshaft actuator retains its position; whereas, at a lower pulse-duty factor, a movement takes place in one direction (for example, in a direction toward the reference position which lies at an end stop of the travel path) and, at a greater pulse-duty factor, a movement of the camshaft actuator takes place in the other direction. The particular speed of movement of the camshaft actuator increases with increasing difference to the pulse-duty factor of 50%.

It is understood that the foregoing description is that of the preferred embodiments of the invention and that various changes and modifications may be made thereto without departing from the spirit and scope of the invention as defined in the appended claims.

1. A method for controlling the position of a camshaft actuator, the method comprising the steps of:
controlling the position of a camshaft with respect to a reference position utilizing said camshaft actuator in dependence upon an actual position of said camshaft and in dependence upon a determined desired position of said camshaft;
determining a precontrol component based on state quantities characterizing the operation of said camshaft actuator; and,
determining an actuating signal for driving said camshaft actuator from said desired position and an actual position of said camshaft while considering said precontrol component.

2. The method of claim 1, wherein said camshaft actuator is in an internal combustion engine including an internal combustion engine of a motor vehicle.

3. The method of claim 1, comprising the further step of determining said precontrol component based on selected ones of said state quantities which represent the state of the hydraulic liquid which effects an actuating movement of said camshaft actuator.

4. The method of claim 3, wherein the state quantities, which represent said hydraulic liquid, include at least one of the pressure and temperature thereof.

5. The method of claim 2, wherein one of said state quantities utilized in determining said precontrol component is the on-board voltage.

6. The method of claim 2, further comprising the step of detecting at least a portion of said state quantities via sensors.

7. The method of claim 2, further comprising the step of deriving at least a portion of said state quantities from other quantities measured by sensors with the determination of the state quantities being model supported or being from corresponding characteristic lines.

8. The method of claim 2, further comprising, as said precontrol quantity, a signal by which said actuating signal is changed.

9. The method of claim 7, wherein said actuating signal is changed via an additive or multiplicative logic operation.

10. The method of claim 2, wherein said actuating signal is a clock signal for the actuation of an electromagnetically actuated switch valve opening a fluid path; and, the pulse-duty factor is changed because of the precontrol when supplying current for opening a valve.
